(19) United States
(12) Patent Application Publication
(10) Pub. No.: US 2020/0392380 A1
(43) Pub. Date: Dec. 17, 2020

(54) DOUBLE-SIDED ADHESIVE TAPE

(71) Applicant: Microsoft Technology Licensing, LLC, Redmond, WA (US)

(72) Inventors: Cheng CHEN, Shanghai (CN); Michael Joseph LANE, Bellevue, WA (US); Xiaole ZHAO, Singapore (SG)

(73) Assignee: Microsoft Technology Licensing, LLC, Redmond, WA (US)

(21) Appl. No.: 16/440,628

(22) Filed: Jun. 13, 2019

(51) Int. Cl. C09J 7/35; C09J 5/06; C09J 7/38; C09J 7/25; C09J 7/24; C09J 7/28; C09J 7/26

(52) U.S. Cl. CPC C09J 7/35; C09J 2475/006; C09J 7/383; C09J 7/38; C09J 7/385; C09J 7/255; C09J 7/25; C09J 7/245; C09J 7/28; C09J 7/26; C09J 2203/326; C09J 2205/114; C09J 2400/243; C09J 2400/24; C09J 2400/163; C09J 2475/00; C09J 2423/04; C09J 2431/00; C09J 2461/00; C09J 2421/00; C09J 2407/00; C09J 2483/00; C09J 2433/00; C09J 2467/006; C09J 2469/006; C09J 2431/006; C09J 2423/046; C09J 2479/086; C09J 5/06

(57) ABSTRACT

A double-sided adhesive tape is provided, which includes a pressure-sensitive adhesive layer on a first side of the adhesive tape, a thermal bonding film layer on a second side of the adhesive tape, and a carrier layer interposing the thermal bonding film layer and the pressure-sensitive adhesive layer. A total thickness of the adhesive tape is 50-500 μm.

### BACKGROUND

Double-sided adhesive tapes are used in a wide variety of applications. For example, double-sided adhesive tapes may be used to hold two components together in an assembled product, such as an electronic device. In a related usage, such adhesive tapes may be used to reduce vibrations transmitted between such components.

### SUMMARY

A double-sided adhesive tape is disclosed herein, which may include a pressure-sensitive adhesive layer on a first side of the adhesive tape, a thermal bonding film layer on a second side of the adhesive tape, and a carrier layer interposing the thermal bonding film layer and the pressure-sensitive adhesive layer. A total thickness of the adhesive tape may be 50-500 μm.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a double-sided adhesive tape according to a first embodiment.

FIG. 2 shows a double-sided adhesive tape according to a second embodiment.

FIG. 3 shows a double-sided adhesive tape according to a third embodiment.

FIG. 4 shows an exemplary manufacture process for the double-sided adhesive tape according to the first and second embodiments.

FIG. 5 shows an exemplary manufacture process for the double-sided adhesive tape according to the third embodiment.

FIG. 6 shows a flowchart of a bonding method for the double-sided adhesive tape of the present invention.

### DETAILED DESCRIPTION

As electronic devices such as televisions, computers, and mobile devices become thinner and more complex, bonding requirements for manufacture of the devices become stricter. To conserve space, a narrow adhesive width may be desired, and taller gaps may be bridged by the adhesive in order to cope with restrictions on possible arrangements of components. Conventional adhesives may fail under such circumstances due to either an increased thickness causing cross-linking failure, or a decreased width reducing the necessary surface area for the adhesive to firmly bond to a component. In addition, each side to be joined by an adhesive can have different properties, affecting the suitability of the adhesive.

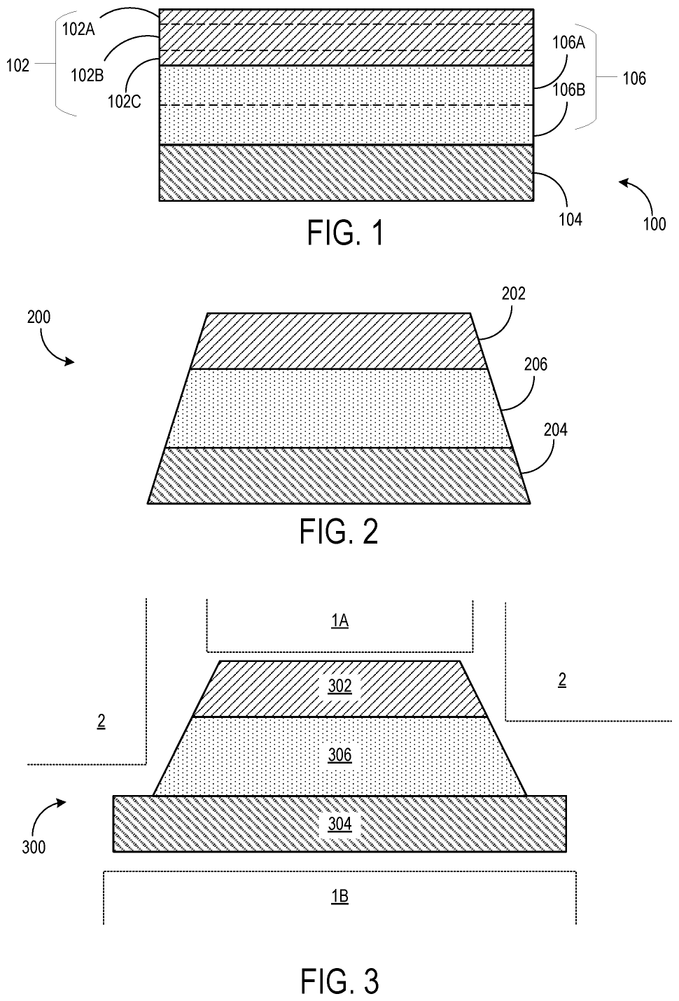

FIG. 1 shows a double-sided adhesive tape 100 according to a first embodiment. The adhesive tape 100 may include a pressure-sensitive adhesive (PSA) layer 102 on a first side of the adhesive tape 100 and a thermal bonding film (TBF) layer 104 on a second side of the adhesive tape 100. Accordingly, the adhesive tape 100 may be configured to bond to two substrates with differing properties affecting adhesion. Different materials of the substrates may affect the suitability of a given adhesive, and the presence of a coating on a substrate surface can also affect bonding by the adhesive. For example, if a substrate has a nickel or zinc coating, the adhesive tape 100 with two types of adhesive layers may still be effective at bonding the substrate to another component. Further, an expected operating temperature of, or near, the substrate may be render various adhesives unsuitable. For example, PSA adhesion failure typically increases as temperature increases. By using one PSA layer 102 and one TBF layer 104, the TBF layer 104 exhibiting increased adhesion at higher temperatures may be used to bond to a component that operates at a higher temperature, while the PSA layer 102 may be used to bond to a component which operates at room temperature, for example.

As discussed briefly above, restrictions on possible arrangements of components may lead to taller gaps being bridged by the adhesive. For example, bond gaps over 250 μm in a device may occur more frequently as device designs grow stricter. A TBF cross-links during a curing process to produce a strong, durable bond. For example, at a shorter bond gap of about 50-199 μm, the cross-linking may proceed normally. However, when a thick TBF tape is used in a tall bond gap, for example, about 200 μm or more, the cross-linking may fail and the TBF may end up too soft to reliably hold bonded components in place. Accordingly, the adhesive tape 100 may include a carrier layer 106 interposing the thermal bonding film layer 104 and the pressure-sensitive adhesive layer 102. The carrier layer 106 may increase the distance between the TBF layer 104 and the PSA layer 102 such that a total thickness of the adhesive tape is 50-500 μm. Preferably, the total thickness of the adhesive tape may be 200-400 μm. The thickness of the individual layers may be independently adjusted to a suitable size. For example, the thickness of the TBF layer 104 may be 15-200 μm, preferably 50-150 μm, more preferably about 100 μm; the thickness of the PSA layer 102 may be 15-200 μm, preferably 50-125 μm, more preferably about 50 μm; and the thickness of the carrier layer 106 may be 20-250 μm, preferably 50-200 μm, more preferably about 100-150 μm. By including the carrier layer 106, tall bond gaps may be bridged while reducing cross-link failure in the TBF layer or heat softening of the PSA layer. The adhesive tape 100 may also exhibit superior performance in tall bond gaps compared to a common double-sided tape or a liquid adhesive.

In advanced electronics design, the width of the surface available for bonding in a crowded interior may be less than conventional adhesive tapes. Accordingly, a width of the adhesive tape may be 2-5 mm. The issues discussed above regarding bridging tall bond gaps may be magnified when a narrow adhesive tape is used because the surface area may not be sufficient. However, due to the combination of layers, the adhesive tape 100 may exhibit strong adhesive properties even when narrow and/or thick.

Regarding the materials of the adhesive tape 100, the pressure-sensitive adhesive layer 102 may include at least one of the group consisting of natural rubber, synthetic rubber, silicone rubber, and polyacrylate. As shown in dashed lines in FIG. 1, while the PSA layer 102 may be a single layer, multiple sub-layers 102A-C may instead be included. For example, a double-sided PSA tape may be used as the PSA layer 102, and thus the middle sub-layer 102B may be another carrier layer of a material suitable for the carrier layer 106, detailed below.

The thermal bonding film layer 104 may include at least one of the group consisting of polyurethane, polyacrylate, ethylene vinyl acetate, and a mixture of nitrile rubber and phenolic resin (nitrile-phenolic resin). One or more types of the carrier layer 106 may be included (e.g., carrier sub-layers 106A, 106B) based on the conditions expected or desired at the bonding sites. For example, the carrier layer 106 may include a polymeric film formed of at least one of the group consisting of: polycarbonate, ethylene-vinyl acetate, polyester, and polyimide. Alternatively or additionally, the carrier layer 106 may include a metal film formed of at least one of the group consisting of aluminum and copper. When the carrier layer 106 includes a polymeric film or a metal film, component slip may be reduced, rigid support for adhered components may be provided, and cosmetic consistency and levelness may be exhibited. Alternatively or additionally, the carrier layer 106 may include a foamed polymeric film formed of polyurethane, and/or the carrier layer may include a foamed pressure-sensitive adhesive. When the carrier layer 106 includes a foamed layer, impacts to the device as a whole or to an individual adhered component may be absorbed, protecting the device from damage. Furthermore, movement of the adhered component from such an impact may be absorbed to prevent the movement from being transferred to other components. Thus, a foamed layer may be included when the adhesive tape 100 is used in a device prone to receiving impact, such as mobile electronic devices that are commonly dropped, or when bonding more delicate components than others.

FIG. 2 shows a double-sided adhesive tape 200 according to a second embodiment, and FIG. 3 shows a double-sided adhesive tape 300 according to a third embodiment. Other than the shape of the adhesive tapes 200, 300, characteristics of the adhesive tape 100 may be utilized, and redundant description thereof will be omitted. As shown in dashed lines in FIG. 3 by way of example, each substrate 1A, 1B to be bonded by the adhesive tape 200 or 300 may have different shapes which are also different than the adhesive. Further, additional components not to be joined but which present obstacles to adhering the substrates 1A, 1B together using the rectangular adhesive tape 100, may affect the profile of the gap to be filled by the adhesive tape 200, 300. Accordingly, in a lateral cross-sectional view, a shape of the pressure-sensitive adhesive layer 102 may be different than a shape of the thermal bonding film layer 104. Each shape may be formed to correspond to the gap profile, and the illustrated embodiments are merely examples. In the second embodiment, the adhesive tape 200 is formed as a non-rectangular shape, illustrated here as a trapezoid. The side edges of the trapezoid shape may be adjusted to a suitable angle. While a PSA layer 202 is shown as the short layer while a TBF layer 204 is shown as the long layer, the order of layers may be reversed. A carrier layer 206 may also be formed to be the same size as the adjacent surfaces of the adhesive layers 202, 204 so as to provide sufficient support for each adhesive layer 202, 204 as well as sufficiently even pressure during bonding.

In the third embodiment, a PSA layer 302 and a carrier layer 306 are formed as a trapezoid, and a TBF layer 304 is formed as a wider rectangle. As in the second embodiment, the order of the layers may be reversed so that the TBF layer 304 and the carrier layer 306 are formed as a trapezoid, and the PSA layer 302 is formed as a wider rectangle. Furthermore, suitable shapes other than trapezoids and rectangles may be used, according to the gap profile and the ease of manufacture. In the example shown in FIG. 3, the smaller PSA layer 302 is able to fit through the additional components 2 to reach the substrate 1A, the carrier layer 306 avoids interfering with the additional components 2, and the unconstrained TBF layer 304 is able to adhere to a wide surface of the substrate 1B. Further, rather than the additional components 2 limiting the shape of the adhesive tape 200, 300, the substrate 1A itself may not have a simple flat surface, and may instead have grooves, ridges, depressions, protrusions, and/or slopes, for example, and the adhesive tape 200, 300 may be shaped accordingly.

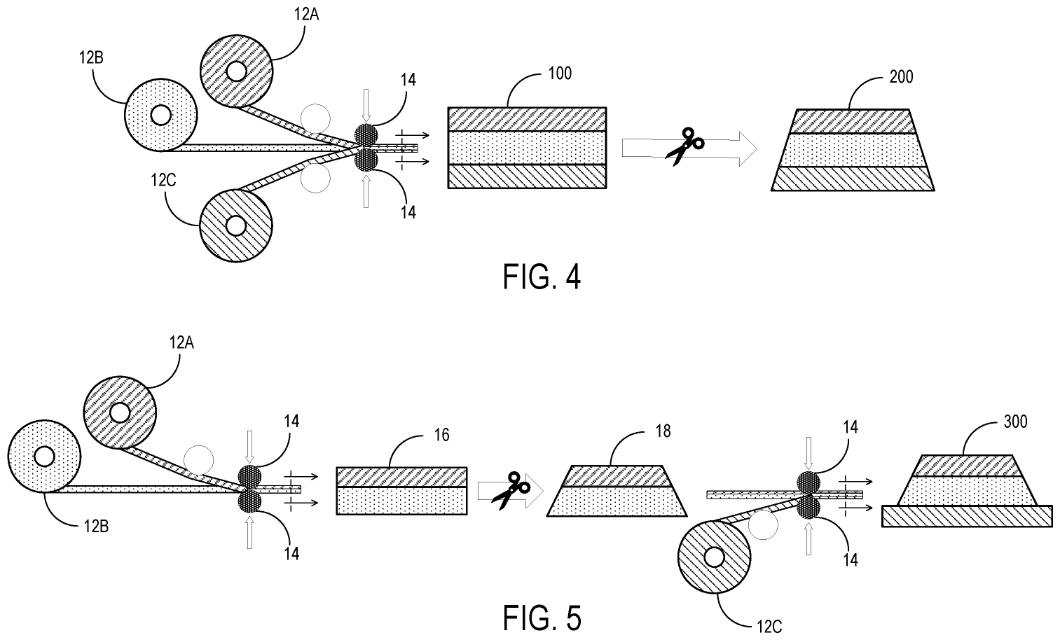

FIG. 4 shows an exemplary manufacture process for the double-sided adhesive tape 100, 200 according to the first and second embodiments, and FIG. 5 shows an exemplary manufacture process for the double-sided adhesive tape 300 according to the third embodiment. It will be appreciated that other suitable processes may be employed. Starting with FIG. 4, three sources (here, rolls) 12A-C of the materials forming each layer of the adhesive tape 100, 200 are provided. If a given layer is formed of multiple sub-layers, the sub-layers may be joined together preliminarily, or else more than three sources 12A-C may be provided. Heated rollers 14 may apply heat and pressure to the individual layers to form a sandwich, as shown in the lateral cross-sectional view of the adhesive tape 100. The temperature and pressure of the rollers 14 may depend on the materials used in the TBF layers 104, 204. For example, the temperature may be about 45-55° C. and the pressure may be about 1-3 bar. Next, the adhesive tape 200 may be formed from the adhesive tape 100 by cutting. The cutting may be performed by die cutting or laser cutting, for example. Further, the width of an intermediate tape produced by lamination may be around 200-500 mm before being cut to around 2-5 mm when producing the adhesive tape 100, 200. When applied to the substrates 1A, 1B, a tab of a suitable length may be cut from the adhesive tape 100, 200.

In FIG. 5, two sources 12A, 12B are used to initially form a two-layer adhesive tape 16 using heat and/or pressure from rollers 14. This single-sided adhesive tape 16 is then cut, which may be performed by die cutting or laser cutting, for example, to produce a trapezoidal two-layer adhesive tape 18. Then, the third source 12C may be used to add the remaining adhesive layer, again using heat and/or pressure from rollers 14, to yield the adhesive tape 300 of the third embodiment.

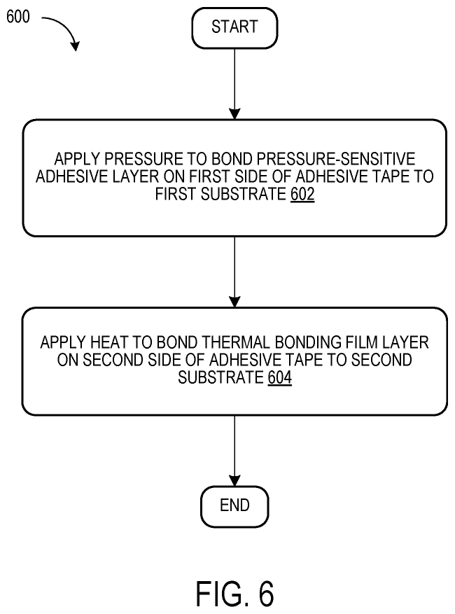

FIG. 6 shows a flowchart of a bonding method 600 for the double-sided adhesive tape of the present invention. The following description of method 600 is provided with reference to the double-sided adhesive tapes described above and shown in FIGS. 1-3.

With reference to FIG. 6, at 602, the method 600 may include applying pressure to bond a pressure-sensitive adhesive layer on a first side of the adhesive tape to a first substrate. At 604, the method 600 may include applying heat to bond a thermal bonding film layer on a second side of the adhesive tape to a second substrate. As discussed above, the thermal bonding film layer may include at least one of the group consisting of polyurethane, polyacrylate, ethylene vinyl acetate, and nitrile-phenolic resin.

In addition, a carrier layer may interpose the thermal bonding film layer and the pressure-sensitive adhesive layer. As discussed above, the carrier layer may include a polymeric film formed of at least one of the group consisting of; polycarbonate, ethylene-vinyl acetate, and polyimide; the carrier layer may include a metal film formed of at least one of the group consisting of aluminum and copper; the carrier layer may include a foamed polymeric film formed of polyurethane; and/or the carrier layer may include a foamed pressure-sensitive adhesive.

A total thickness of the adhesive tape used in method 600 and comprising the pressure-sensitive adhesive layer, the thermal bonding film layer, and the carrier layer, may be 50-500 μm. Preferably, the total thickness of the adhesive tape may be 200-400 μm. Further, a width of the adhesive tape may be 2-5 mm. In addition, as shown in FIGS. 2 and 3, in a lateral cross-sectional view, a shape of the pressure-sensitive adhesive layer may be different than a shape of the thermal bonding film layer.

As discussed above, electronic devices are having increasingly strict design considerations leading to wider, narrower, and irregularly shaped gaps to be filled by an adhesive when bonding two components together. The double-sided adhesive tape described above may allow for customization of adhesive properties while bridging such gaps so that the components are firmly bonded together even under conditions previously thought unsuitable for mounting.

The following paragraphs provide additional support for the claims of the subject application. One aspect provides a double-sided adhesive tape comprising a pressure-sensitive adhesive layer on a first side of the adhesive tape, a thermal bonding film layer on a second side of the adhesive tape, and a carrier layer interposing the thermal bonding film layer and the pressure-sensitive adhesive layer. A total thickness of the adhesive tape is 50-500 μm. In this aspect, additionally or alternatively, the total thickness of the adhesive tape is 200-400 μm. In this aspect, additionally or alternatively, the carrier layer includes a polymeric film formed of at least one of the group consisting of: polyethylene terephthalate, polycarbonate, ethylene-vinyl acetate, polyester, and polyimide. In this aspect, additionally or alternatively, the carrier layer includes a metal film formed of at least one of the group consisting of aluminum and copper. In this aspect, additionally or alternatively, the carrier layer includes a foamed polymeric film formed of polyurethane. In this aspect, additionally or alternatively, the carrier layer includes a foamed pressure-sensitive adhesive. In this aspect, additionally or alternatively, the thermal bonding film layer includes at least one of the group consisting of polyurethane, polyacrylate, ethylene vinyl acetate, and nitrile-phenolic resin. In this aspect, additionally or alternatively, the pressure-sensitive adhesive layer includes at least one of the group consisting of natural rubber, synthetic rubber, silicone rubber, and polyacrylate. In this aspect, additionally or alternatively, a width of the adhesive tape is 2-5 mm. In this aspect, additionally or alternatively, in a lateral cross-sectional view, a shape of the pressure-sensitive adhesive layer is different than a shape of the thermal bonding film layer.

Another aspect provides a bonding method for a double-sided adhesive tape. The method comprises applying pressure to bond a pressure-sensitive adhesive layer on a first side of the adhesive tape to a first substrate, and applying heat to bond a thermal bonding film layer on a second side of the adhesive tape to a second substrate, wherein a carrier layer interposes the thermal bonding film layer and the pressure-sensitive adhesive layer, and a total thickness of the adhesive tape comprising the pressure-sensitive adhesive layer, the thermal bonding film layer, and the carrier layer is 50-500 μm. In this aspect, additionally or alternatively, the total thickness of the adhesive tape is 200-400 μm. In this aspect, additionally or alternatively, the carrier layer includes a polymeric film formed of at least one of the group consisting of: polycarbonate, ethylene-vinyl acetate, polyester, and polyimide. In this aspect, additionally or alternatively, the carrier layer includes a metal film formed of at least one of the group consisting of aluminum and copper. In this aspect, additionally or alternatively, the carrier layer includes a foamed polymeric film formed of polyurethane. In this aspect, additionally or alternatively, the carrier layer includes a foamed pressure-sensitive adhesive. In this aspect, additionally or alternatively, the thermal bonding film layer includes at least one of the group consisting of polyurethane, polyacrylate, ethylene vinyl acetate, and nitrile-phenolic resin. In this aspect, additionally or alternatively, a width of the adhesive tape is 2-5 mm. In this aspect, additionally or alternatively, in a lateral cross-sectional view, a shape of the pressure-sensitive adhesive layer is different than a shape of the thermal bonding film layer.

Another aspect provides a double-sided adhesive tape, comprising a pressure-sensitive adhesive layer on a first side of the adhesive tape, a thermal bonding film layer on a second side of the adhesive tape, and a carrier layer interposing the thermal bonding film layer and the pressure-sensitive adhesive layer. A total thickness of the adhesive tape is 200-400 μm, and in a lateral cross-sectional view, a shape of the pressure-sensitive adhesive layer is different than a shape of the thermal bonding film layer.

It will be understood that the configurations and/or approaches described herein are exemplary in nature, and that these specific embodiments or examples are not to be considered in a limiting sense, because numerous variations are possible. The specific processes or methods described herein may represent one or more of any number of strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A double-sided adhesive tape, comprising:
a pressure-sensitive adhesive layer on a first side of the adhesive tape;
a thermal bonding film layer on a second side of the adhesive tape; and
a carrier layer interposing the thermal bonding film layer and the pressure-sensitive adhesive layer, wherein
a total thickness of the adhesive tape is 50-500 μm.

2. The adhesive tape of claim 1, wherein the total thickness of the adhesive tape is 200-400 μm.

3. The adhesive tape of claim 1, wherein the carrier layer includes a polymeric film formed of at least one of the group consisting of: polyethylene terephthalate, polycarbonate, ethylene-vinyl acetate, polyester, and polyimide.

4. The adhesive tape of claim 1, wherein the carrier layer includes a metal film formed of at least one of the group consisting of aluminum and copper.

5. The adhesive tape of claim 1, wherein the carrier layer includes a foamed polymeric film formed of polyurethane.

6. The adhesive tape of claim 1, wherein the carrier layer includes a foamed pressure-sensitive adhesive.

7. The adhesive tape of claim 1, wherein the thermal bonding film layer includes at least one of the group consisting of polyurethane, polyacrylate, ethylene vinyl acetate, and nitrile-phenolic resin.

8. The adhesive tape of claim 1, wherein the pressure-sensitive adhesive layer includes at least one of the group consisting of natural rubber, synthetic rubber, silicone rubber, and polyacrylate.

9. The adhesive tape of claim 1, wherein a width of the adhesive tape is 2-5 mm.

10. The adhesive tape of claim 1, wherein in a lateral cross-sectional view, a shape of the pressure-sensitive adhesive layer is different than a shape of the thermal bonding film layer.

11. A bonding method for a double-sided adhesive tape, the method comprising:
applying pressure to bond a pressure-sensitive adhesive layer on a first side of the adhesive tape to a first substrate; and
applying heat to bond a thermal bonding film layer on a second side of the adhesive tape to a second substrate, wherein
a carrier layer interposes the thermal bonding film layer and the pressure-sensitive adhesive layer, and
a total thickness of the adhesive tape comprising the pressure-sensitive adhesive layer, the thermal bonding film layer, and the carrier layer is 50-500 μm.

12. The method of claim 11, wherein the total thickness of the adhesive tape is 200-400 μm.

13. The method of claim 11, wherein the carrier layer includes a polymeric film formed of at least one of the group consisting of: polycarbonate, ethylene-vinyl acetate, polyester, and polyimide.

14. The method of claim 11, wherein the carrier layer includes a metal film formed of at least one of the group consisting of aluminum and copper.

15. The method of claim 11, wherein the carrier layer includes a foamed polymeric film formed of polyurethane.

16. The method of claim 11, wherein the carrier layer includes a foamed pressure-sensitive adhesive.

17. The method of claim 11, wherein the thermal bonding film layer includes at least one of the group consisting of polyurethane, polyacrylate, ethylene vinyl acetate, and nitrile-phenolic resin.

18. The method of claim 11, wherein a width of the adhesive tape is 2-5 mm.

19. The method of claim 11, wherein in a lateral cross-sectional view, a shape of the pressure-sensitive adhesive layer is different than a shape of the thermal bonding film layer.

20. A double-sided adhesive tape, comprising:
a pressure-sensitive adhesive layer on a first side of the adhesive tape;
a thermal bonding film layer on a second side of the adhesive tape; and
a carrier layer interposing the thermal bonding film layer and the pressure-sensitive adhesive layer, wherein
a total thickness of the adhesive tape is 200-400 μm, and
in a lateral cross-sectional view, a shape of the pressure-sensitive adhesive layer is different than a shape of the thermal bonding film layer.
